(19) United States
(12) Patent Application Publication
(10) Pub. No.: US 2025/0307680 A1
(43) Pub. Date: Oct. 2, 2025

(54) QUANTUM-ENABLED INTELLIGENT TRANSMISSION SYSTEM

(71) Applicant: Bank of America Corporation, Charlotte, NC (US)

(72) Inventors: Antony Robert Raj, Kaniyakumari (IN); Aiswarya Chandrasekaran, Chennai (IN); Raghavendra Veerupakshappa, Ranga Reddy (IN); Ravi Ranjan Shandilya, Hyderabad (IN); Selvaraj Muthurakkianan, Chennai (IN); Iruvanti John Dinakar, Bhadradri (IN)

(21) Appl. No.: 18/619,481

(22) Filed: Mar. 28, 2024

(51) Int. Cl. G06N 10/60

(52) U.S. Cl. CPC G06N 10/60

(57) ABSTRACT

Aspects related to a quantum-enabled intelligent transmission system are provided. An intelligent transmission platform may train a quantum analysis model to identify predicted solutions and output actual solution actions. The platform may receive information of a file corresponding to a failed transmission. The platform may identify a root cause of the failed transmission using the model. The platform may further identify a predicted solution using the model. The platform may cause, based on identifying the predicted solution, initiation of a response to the failed transmission. The response to the failed transmission may comprise implementing an actual solution action generated by the model or erasing a file corresponding to the failed transmission. The platform may output, based on the response to the failed transmission, a notification. The platform may update, based on the predicted solution, the model.

### BACKGROUND

Aspects described herein are related to a quantum-enabled intelligent transmission system. In some instances, entities such as an enterprise organization (e.g., a financial institution, and/or other institutions) may maintain one or more networks of associated devices (e.g., user devices, such as laptops, cell phones, and the like, corresponding to employees and/or customers of the enterprise organization, and/or servers, server blades, or the like) that send, transfer, and/or otherwise transmit data (e.g., information, files, or the like) to other associated devices. In some instances, various challenges (e.g., network issues, hardware issues, manual error, cybersecurity issues, and/or other challenges) may prevent (e.g., block, or otherwise prevent) or hamper these transmissions. In conventional systems a source device initiating a transmission might not be intimated to the reason a transmission fails when the transmissions are blocked/prevented or hampered by these challenges. As a result, the cause of the transmission failure might not be remedied, and transmitted data may be distorted, incorrect, incomplete, or delayed because the source system is unable to address the transmission error. Accordingly, it may be important to efficiently and accurately identify the root cause of a transmission failure, identify a solution to the root cause, and implement the solution such that the transmission and/or future transmissions is/are completed successfully.

### SUMMARY

Aspects of the disclosure provide effective, efficient, scalable, and convenient technical solutions that address and overcome the technical problems associated with current methods of managing network transmissions. In accordance with one or more arrangements of the disclosure, a computing platform with at least one processor, a communication interface, and memory storing computer-readable instructions may train a quantum analysis model. The computing platform may train the quantum analysis model based on historical transmission information. Training the quantum analysis model may configure the quantum analysis model to identify predicted solutions and output actual solution actions based on input of information of failed transmissions. The computing platform may receive information of a file corresponding to the failed transmission based on a failed transmission from a first device to a second device. The computing platform may identify a root cause of the failed transmission. The computing platform may identify the root cause of the failed transmission based on inputting the information of the file into the quantum analysis model. The computing platform may identify a predicted solution for the failed transmission. The computing platform may identify the predicted solution based on identifying the root cause of the failed transmission and using the quantum analysis model. The computing platform may cause initiation of a response to the failed transmission. The computing platform may cause initiation of the response to the failed transmission based on identifying the predicted solution for the failed transmission. The response to the failed transmission may comprise identifying, using the quantum analysis model, whether the predicted solution is resolvable by the quantum analysis model. The response to the failed transmission may, based on identifying that the predicted solution is resolvable by the quantum analysis model, comprise implementing an actual solution action corresponding to the failed transmission. The response to the failed transmission may, based on identifying that the predicted solution is not resolvable by the quantum analysis model, comprise erasing the file corresponding to the failed transmission. The computing platform may cause output of a notification of the response to the failed transmission. The computing platform may cause output of the notification based on the initiation of the response to the failed transmission and to the first device. The computing platform may update, based on the predicted solution, the quantum analysis model.

In one or more arrangements, implementing the actual solution action may comprise one or more of: generating, using the quantum analysis model, executable code configured to resolve one or more errors associated with the failed transmission, or sending, to the first device, a recommendation of one or more actions configured to resolve one or more errors associated with the failed transmission. In one or more examples, identifying the root cause of the failed transmission may comprise comparing, using the quantum analysis model, the information of the file corresponding to the failed transmission to one or more stored correlations corresponding to the historical transmission information. Identifying the root cause of the failed transmission may comprise identifying, based on the comparison, whether the root cause corresponds to a historical root cause of a historical failed transmission.

In one or more arrangements, the computing platform may generate, based on identifying the root cause of the failed transmission, a reason log corresponding to the failed transmission. The computing platform may store the reason log as a training record. The computing platform may update the quantum analysis model further based on the stored reason log. In one or more examples, the historical transmission information may comprise one or more reason logs. A given reason log may comprise one or more of: an indication of a reason for a failed transmission, an indication of information sent during a failed transmission, timing information related to a failed transmission, and/or a speed associated with a failed transmission.

In one or more arrangements, the computing platform may monitor, via a shared connection over a network, communications between the first device and the second device for failed transmissions. In one or more examples, the information of the file corresponding to the failed transmission may comprise one or more of: a size of the file corresponding to the failed transmission, a count corresponding to a number of additional files corresponding to the failed transmission, a time corresponding to creation of the file corresponding to the failed transmission, a description of the file corresponding to the failed transmission, and/or a speed corresponding to the failed transmission. In one or more arrangements, the computing platform may cause, based on initiation of the response to the failed transmission, completion of the failed transmission.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1B depict an illustrative computing environment for a quantum-enabled intelligent transmission system in accordance with one or more example arrangements;

FIGS. 2A-2D depict an illustrative event sequence for a quantum-enabled intelligent transmission system in accordance with one or more example arrangements;

FIGS. 3A-3B depict illustrative graphical user interfaces depicting a solution notification interface and a solution recommendation interface generated as part of a quantum- enabled intelligent transmission system in accordance with one or more example arrangements; and

FIG. 4 depicts an illustrative method for a quantum-enabled intelligent transmission system in accordance with one or more example arrangements.

### DETAILED DESCRIPTION

In the following description of various illustrative arrangements, reference is made to the accompanying drawings, which form a part hereof, and in which is shown, by way of illustration, various arrangements in which aspects of the disclosure may be practiced. In some instances, other arrangements may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As a brief description of the concepts described further herein, some aspects of the disclosure relate to a quantum-enabled intelligent transmission system. In some instances, entities such as an enterprise organization (e.g., a financial institution, and/or other institutions) may maintain a network of associated devices (e.g., devices, such as laptops, cell phones, and the like, corresponding to employees and/or customers of the enterprise organization, and/or servers, server blades, or the like, associated with the enterprise organization) that send, transfer, and/or otherwise transmit data (e.g., information, files, or the like) to other associated devices. In some instances, the transmissions may fail to complete successfully based on being blocked and/or hampered. In conventional systems a source device initiating a transmission might not be intimated to the reason a transmission fails. As a result, the cause of the transmission failure might not be remedied, and transmitted data may be distorted, incorrect, incomplete, or delayed because the source system is unable to address the transmission error.

Accordingly, in some instances, entities such as an enterprise organization and/or other organizations/institutions may employ an intelligent transmission platform, as described herein. An intelligent transmission platform may leverage a quantum analysis model (e.g., a machine learning model, such as a large language model (LLM), a decoder-only transformer model, or the like, configured to implement quantum analysis) to identify failed transmissions, identify the root cause of the issue that caused a failed transmission, and resolve the issue without inefficient back-and-forth between the source system and receiver system. The quantum analysis model may be deployed as a layer between the source and receiver systems and implemented in quantum to provide high-speed issue detection, root cause analysis, and resolution of transmission errors. The quantum analysis model may be trained based on historical transmission information to identify issues likely to cause transmission error (e.g., mismatched file sizes, mismatched initialization times, the speed of the transfer, etc.). The quantum analysis model may monitor network activity between source systems and receiver systems and intercept information of files for transmissions that are blocked (i.e., that experience some error). Based on inputting the information of the files into the quantum analysis model, the model may identify issues and generate reason logs that describe the file being transferred, the reason for the failure, timing info, and other information. The reason logs may be used to refine/update/configure the quantum analysis model to improve efficiency and accuracy of the error detection process. Additionally, the intelligent transmission platform may also generate, using the quantum analysis model, predicted solutions/resolutions to the transmission error. If the error can be resolved automatically, the intelligent transmission system may generate the actual solution (e.g., as code to be implemented, as a recommended solution to be automatically implemented by one or more programs outside of the intelligent transmission platform, and/or in other formats). If the error cannot be resolved automatically, the intelligent transmission system may notify the source system and cause one or more devices to implement a resolution.

These and various other aspects will be discussed more fully herein.

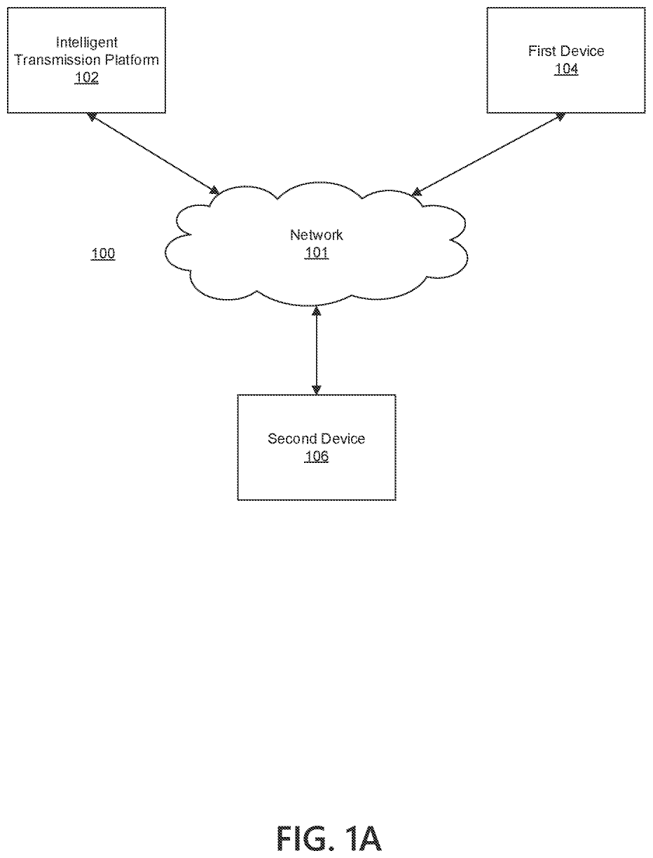

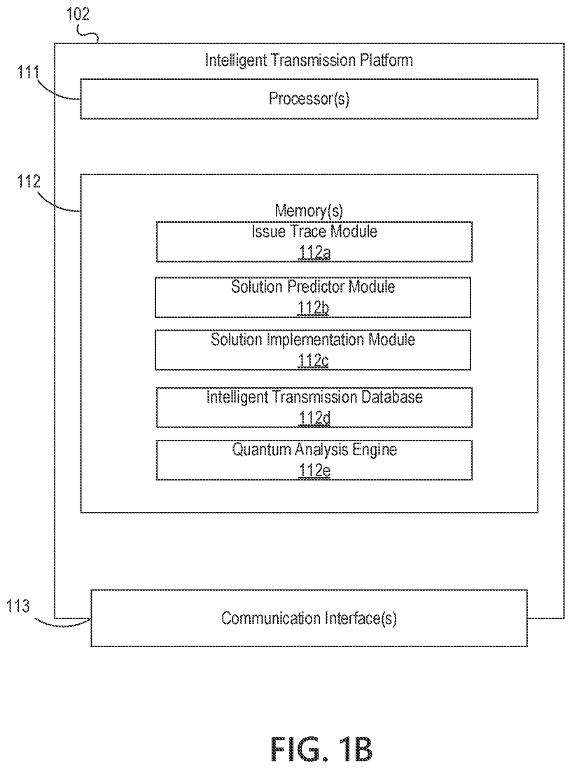

FIGS. 1A-1B depict an illustrative computing environment for a quantum-enabled intelligent transmission system in accordance with one or more example arrangements. Referring to FIG. 1A, computing environment 100 may include one or more computer systems. For example, computing environment 100 may include an intelligent transmission platform 102, a first device 104, a second device 106, and/or other computing devices.

As described further below, intelligent transmission platform 102 may be or include a computer system that includes one or more computing devices (e.g., servers, laptop computers, desktop computers, mobile devices, tablets, smartphones, and/or other devices) and/or other computer components (e.g., processors, memories, communication interfaces) that may be used to monitor transmissions between devices associated with a network, receive information of files corresponding to failed transmissions, identify root causes of failed transmission, identify predicted solutions for failed transmissions, and implement actual solutions for failed transmissions. The intelligent transmission platform 102 may configure, train, and/or execute one or more machine learning models (e.g., a quantum analysis model, such as a LLM, a transformation model, and/or other models). For example, the intelligent transmission platform 102 may train a quantum analysis model to identify predicted solutions and output actual solution actions based on input of information of failed transmissions. The intelligent transmission platform 102 may be managed by and/or otherwise associated with an enterprise organization (e.g., a financial institution, and/or other institutions) that may, e.g., be associated with one or more additional systems (e.g., first device 104, second device 106, and/or other systems). In one or more instances, the intelligent transmission platform 102 may be configured to communicate with one or more systems (e.g., first device 104, second device 106, and/or other systems) to perform an information transfer, implement actual solution actions, identify predicted solutions, and/or perform other functions.

The first device 104 may be a computing device (e.g., server, server blade, or the like) and/or other data storing or computing component (e.g., processors, memories, communication interfaces, databases) that may be used to transfer information between devices and/or perform other functions (e.g., execute information transfers, display user interfaces, and/or other functions). The first device 104 may correspond to an entity (e.g., an enterprise organization, such as a financial institution and/or other institution). For example, the first device 104 may correspond to the same entity associated with the intelligent transmission platform 102. In one or more instances, the first device 104 may be configured to communicate with one or more systems (e.g., intelligent transmission platform 102, second device 106, and/or other systems) as part of sending a transmission, and/or to perform other functions.

The second device 106 may be a computing device (e.g., server, server blade, or the like) and/or other data storing or computing component (e.g., processors, memories, communication interfaces, databases) similar to first device 104 that may be used to transfer information between devices and/or perform other functions. The second device 106 may correspond to an entity (e.g., an enterprise organization, such as a financial institution and/or other institution). For example, the second device 106 may correspond to the same entity associated with the intelligent transmission platform 102. In one or more instances, the second device 106 may be configured to communicate with one or more systems (e.g., intelligent transmission platform 102, first device 104, and/or other systems) as part of receiving a transmission, and/or to perform other functions

Although a first device 104 and a similar second device 106 are depicted herein, any number of such devices may be used to implement the methods and arrangements described herein without departing from the scope of the disclosure.

Computing environment 100 also may include one or more networks, which may interconnect intelligent transmission platform 102, first device 104, and second device 106. For example, computing environment 100 may include a network 101 (which may interconnect, e.g., intelligent transmission platform 102, first device 104, and second device 106,).

In one or more arrangements, intelligent transmission platform 102, first device 104, and second device 106 may be any type of computing device capable of sending and/or receiving requests and processing the requests accordingly. For example, intelligent transmission platform 102, first device 104, second device 106, and/or the other systems included in computing environment 100 may, in some instances, be and/or include server computers, desktop computers, laptop computers, tablet computers, or the like that may include one or more processors, memories, communication interfaces, storage devices, and/or other components. As noted above, and as illustrated in greater detail below, any and/or all of intelligent transmission platform 102, first device 104, and second device 106 may, in some instances, be special-purpose computing devices configured to perform specific functions.

Referring to FIG. 1B, intelligent transmission platform 102 may include one or more processors 111, memory 112, and communication interface 113. A data bus may interconnect processor 111, memory 112, and communication interface 113. Communication interface 113 may be a network interface configured to support communication between intelligent transmission platform 102 and one or more networks (e.g., network 101, or the like). Communication interface 113 may be communicatively coupled to the processor 111. Memory 112 may include one or more program modules having instructions that, when executed by processor 111, cause intelligent transmission platform 102 to perform one or more functions described herein, and/or one or more databases (e.g., an intelligent transmission database 112d, or the like) that may store and/or otherwise maintain information which may be used by such program modules and/or processor 111. In some instances, the one or more program modules and/or databases may be stored by and/or maintained in different memory units of intelligent transmission platform 102 and/or by different computing devices that may form and/or otherwise make up intelligent transmission platform 102. For example, memory 112 may have, host, store, and/or include an issue trace module 112a, a solution predictor module 112b, a solution implementation module 112c, an intelligent transmission database 112d, a quantum analysis engine 112e, and/or other modules and/or databases.

In some examples, one or more of the program modules and/or databases may be integrated together, overlap in one or more functions, and/or otherwise be associated with each other. For example, in some instances, one or more of issue trace module 112a, solution predictor module 112b, solution implementation module 112c, and/or other program modules may be combined and/or modified into a single program module. Additionally or alternatively, in some examples, quantum analysis engine 112e may be configured to implement and/or may comprise one or more of issue trace module 112a, solution predictor module 112b, solution implementation module 112c, and/or other modules. Additionally or alternatively, in some examples, the one or more program modules and/or databases may each comprise one or more additional modules and/or additional databases. For example, in some instances, intelligent transmission database 112d may comprise one or more additional databases It should be understood that the specific program modules described herein are merely examples and that one or more additional or alternative program modules may be hosted, stored, and/or otherwise included in memory 112 without departing from the scope of this disclosure.

Issue trace module 112a may have instructions that direct and/or cause intelligent transmission platform 102 to communicate with the network 101, monitor transmissions between devices, receive information of files corresponding to failed transmissions, and/or perform other functions. Solution predictor module 112b may have instructions that direct and/or cause intelligent transmission platform 102 to identify a root cause of a failed transmission, identify a predicted solution for a failed transmission, and/or perform other functions. Solution implementation module 112c may have instructions that direct and/or cause intelligent transmission platform 102 to implement an actual solution action corresponding to a failed transmission, generate a recommended solution corresponding to a failed transmission, cause output of a user interface, and/or perform other functions. Intelligent transmission database 112d may have instructions causing intelligent transmission platform 102 to store reason logs, information of failed transmissions, and/or other information. Quantum analysis engine 112e may have instructions to train, implement, and/or update one or more machine learning models, such as a quantum analysis model, and/or other machine learning models. Although issue trace module 112a, solution predictor module 112b, solution implementation module 112c, intelligent transmission database 112d, and quantum analysis engine 112e are depicted as separate modules herein, the instructions stored by these modules may be stored in any number of modules without departing from the scope of this disclosure.

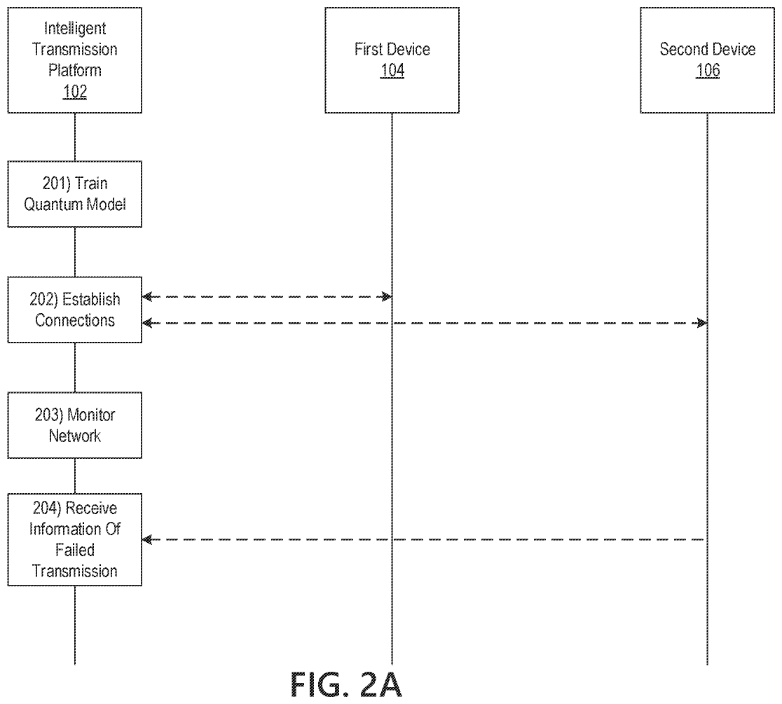

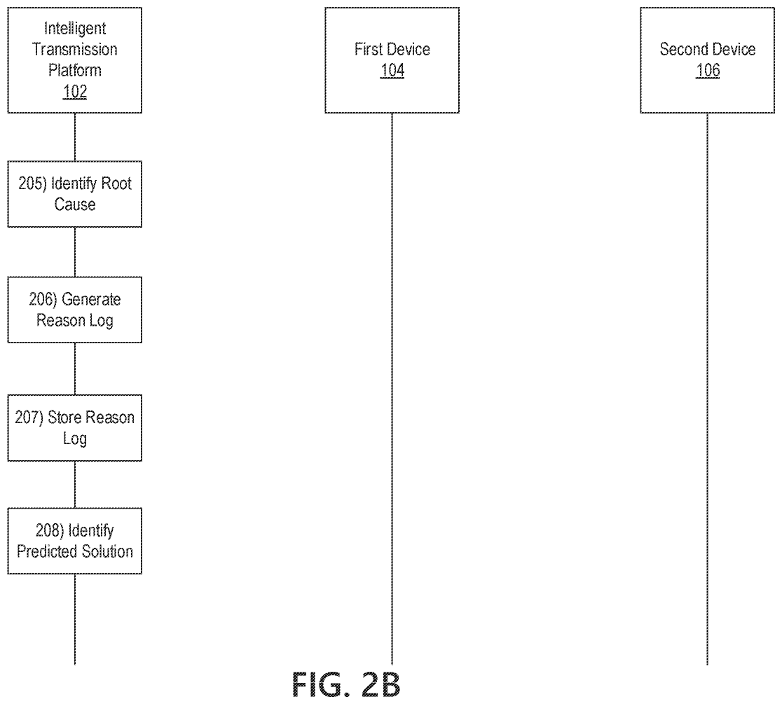

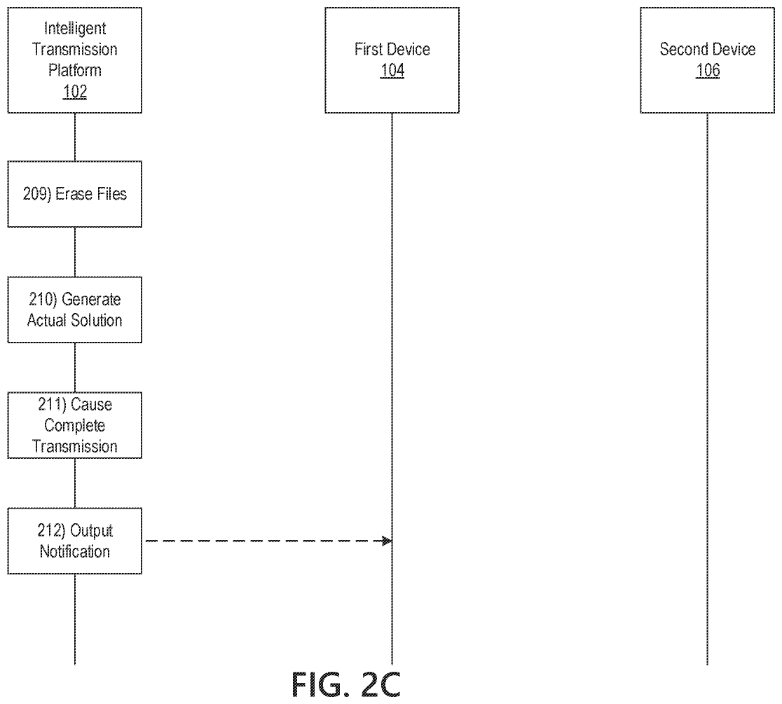

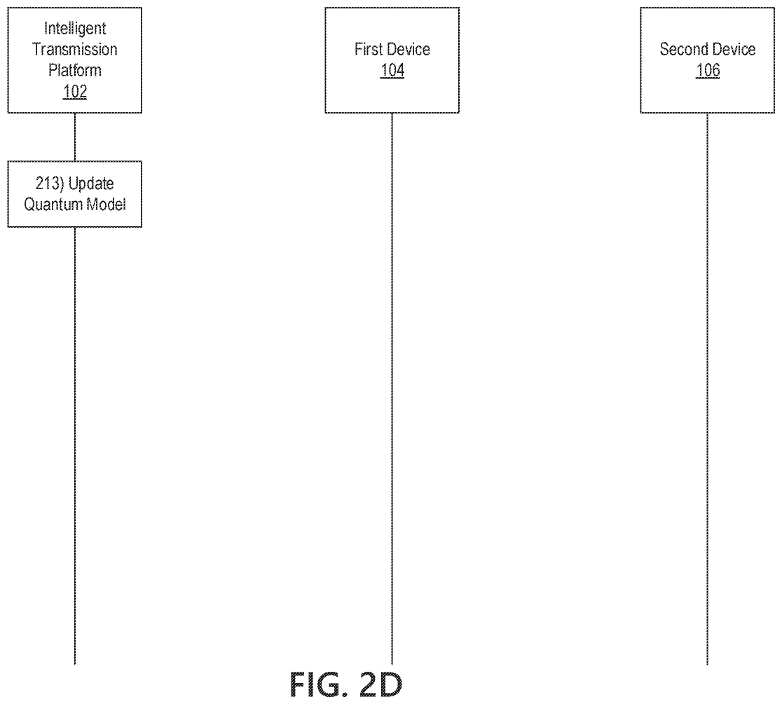

FIGS. 2A-2D depict an illustrative event sequence for a quantum-enabled intelligent transmission system in accordance with one or more example arrangements. Referring to FIG. 2A, at step 201, the intelligent transmission platform 102 may train a machine learning model. For example, the intelligent transmission platform 102 may train a quantum analysis model (e.g., a quantum-enabled large language model (LLM), a quantum-enabled transformation model, such as a decoder-only transformation model, and/or other quantum-enabled machine learning models). Training the quantum analysis model may configure the quantum analysis model to identify predicted solutions to root causes of failed transmissions, output and/or implement actual solution actions (e.g., recommendations of one or more actions configured to resolve errors associated with failed transmissions, executable code configured to resolve errors associated with failed transmissions, and/or other solution actions) based on input of information of failed transmissions (e.g., reason logs, error codes/flags, and/or other information of reasons for a failed transmissions, indications of information sent during a failed transmission (e.g., file identifiers, file sizes, file counts, or the like), timing information related to a failed transmission, speeds associated with a failed transmission, and/or other information of failed transmissions). The intelligent transmission platform 102 may train the quantum analysis model based on historical transmission information. For example, the intelligent transmission platform 102 may configure the quantum analysis model to identify issues (i.e., root causes) associated with failed transmissions based on the historical transmission information. For instance, the intelligent transmission platform 102 may configure the quantum analysis model to identify that a mismatched file size, a mismatched timestamp, a speed of the transmission, and/or other root causes of failed transmissions based on historical transmission information for failed transmissions. In some instances, to configure and/or otherwise train the quantum analysis model, the intelligent transmission platform 102 may process the historical transmission information by applying natural language processing, natural language understanding, supervised machine learning techniques (e.g., regression, classification, neural networks, support vector machines, random forest models, naïve Bayesian models, and/or other supervised techniques), unsupervised machine learning techniques (e.g., principal component analysis, hierarchical clustering, K-means clustering, and/or other unsupervised techniques), and/or other techniques.

In some examples, in configuring and/or otherwise training the quantum analysis model, the intelligent transmission platform 102 may cause the quantum analysis model to generate and store, based on inputting the historical transmission information, one or more correlations between historical failed transmissions and the root causes of failed transmissions. In some examples, the intelligent transmission platform 102 may cause the quantum analysis model to generate and store a correlation between historical failed transmissions and a mismatched file size, mismatched file count, and/or other issues related to files associated with historical failed transmissions. For instance, based on historical transmission information indicating that metadata of a file associated with a failed transmission indicates the file size is 10 kb, but the actual file size is 9 kb, the quantum analysis model may store a correlation (e.g., an error code, an indicator, and/or other correlations) indicating that a mismatched file size was the root cause of the failed transmission. Additionally or alternatively, in some examples, based on historical transmission information indicating that the metadata of a file associated with a failed transmission indicates the file was created at a particular time, but the failed transmission was initiated at a mismatched time (e.g., a time that conflicts with the creation time of the file) the quantum analysis model may store a correlation indicating that a mismatched file creation time was the root cause of the failed transmission. Additionally or alternatively, in some examples, based on historical transmission information indicating that the metadata of a file associated with a failed transmission indicates the file is a particular document type (e.g., a PDF, a text document, or the like) but the actual file is a different document type, the quantum analysis model may store a correlation indicating that a mismatched file description and/or flag was the root cause of the failed transmission. Additionally or alternatively, in some examples, based on historical transmission information indicating that a failed transmission corresponds to a speed (e.g., a speed of the network, and/or other speeds) that hampered and/or prevented to transmission from successfully transferring a file, the quantum analysis model may store a correlation indicating that a mismatched speed of the transmission was the root cause of the failed transmission. For example, a failed transmission may have attempted to transfer a file that is too large in size for the speed corresponding to the failed transmission and the quantum analysis model may store a correlation indicating that, for example, network speed is a root cause of failed transmissions transferring files of the same size as the file size associated with the failed transmission.

It should be understood that the above description of stored correlations merely recites examples of possible stored correlations, and that additional or alternative stored correlations may be generated and stored as part of configuring and/or otherwise training the quantum analysis model without departing from the scope of this disclosure. The intelligent transmission platform 102 may cause the quantum analysis model to store all the correlations in a database accessible by and/or otherwise associated with the quantum analysis model, such as a known error database (KEDB). The intelligent transmission database 112d may be and/or comprise the KEDB.

In some examples, further based on the historical transmission information, the intelligent transmission platform 102 may configure and/or otherwise train the quantum analysis model by storing additional correlations between identified root causes of failed transmissions and implemented solutions. For example, based on storing a correlation indicating that a mismatched speed of the transmission as the root cause of the failed transmission and based on historical transmission information indicating that a successful solution was to compress a file associated with the failed transmission and reinitiate the transmission, the intelligent transmission platform 102 may cause the quantum analysis model to store a correlation between mismatched speeds of transmissions and the solution of compressing a file. Additionally or alternatively, based on storing a correlation indicating that a mismatched file type was the root cause of a failed transmission and based on historical transmission information indicating that executing code and/or initiating one or more computer programs resolved the mismatched file type by identifying and sending the correct file type, the quantum analysis model may store a correlation between mismatched file types and the solution of executing code and/or initiating computer programs to identify and send the correct file type. It should be understood that these are merely examples of the additional correlations that might be stored by the quantum analysis model and that one or more additional or alternative correlations might be stored without departing from the scope of this disclosure. Based on storing the additional correlations, the quantum analysis model may be trained to identify, based on input of information of failed transmissions, the root cause of the failed transmission and a predicted solution using the stored correlations.

At step 202, the intelligent transmission platform 102 may establish one or more connections with devices connected to a network, such as network 101 or the like. In establishing the one or more connections the intelligent transmission platform 102 may be deployed as an intermediate layer between devices that send and receive transmissions via the network 101. For example, the intelligent transmission platform 102 may establish a connection with the first device 104. For example, the intelligent transmission platform 102 may establish a first wireless data connection with the first device 104 to link the first device 104 with the intelligent transmission platform 102 (e.g., in preparation for monitoring transmissions, receiving information of file corresponding to failed transmissions, and/or other functions). In some instances, the intelligent transmission platform 102 may identify whether or not a connection is already established with the first device 104. If a connection is already established with the first device 104, the intelligent transmission platform 102 might not re-establish the connection. If a connection is not yet established with the first device 104, the intelligent transmission platform 102 may establish the first wireless data connection as described above. In some examples, the intelligent transmission platform 102 may establish the connection automatically, as part of an intelligent transmission monitoring process.

In some examples, in establishing the one or more connections, the intelligent transmission platform 102 may additionally establish a connection with the second device 106. For example, the intelligent transmission platform 102 may establish a second wireless data connection with the second device 106 to link the second device 106 with the intelligent transmission platform 102 (e.g., in preparation for monitoring transmissions, receiving information of file corresponding to failed transmissions, and/or other functions). In some instances, the intelligent transmission platform 102 may identify whether or not a connection is already established with the second device 106. If a connection is already established with the second device 106, the intelligent transmission platform 102 might not re-establish the connection. If a connection is not yet established with the second device 106, the intelligent transmission platform 102 may establish the second wireless data connection as described above. In some examples, the intelligent transmission platform 102 may establish the connection automatically, as part of an intelligent transmission monitoring process.

At step 203, based on establishing the one or more connections with devices (e.g., first device 104, second device 106, and/or other devices), the intelligent transmission platform 102 may monitor a network (e.g., network 101, or the like). For example, the intelligent transmission platform 102 may monitor the network for failed transmissions between devices connected to the network, via shared connections established between the intelligent transmission platform 102 and the devices. In some examples, the intelligent transmission platform 102 may monitor the network for failed transmissions by executing one or more programs configured to monitor network activity for failed transmissions, by tracing, via shared connections, communications/transmissions sent from a source device (e.g., first device 104, and/or other devices) to a destination device (e.g., second device 106, and/or other devices) to identify failed transmissions, and/or by other methods.

At step 204, based on a failed transmission from a first device (e.g., first device 104, or the like) to a second device (e.g., second device 106, or the like) and based on identifying a failed transmission while monitoring the network 101 at step 203, the intelligent transmission platform 102 may receive information of the failed transmission. For example, the intelligent transmission platform 102 may receive, from the destination device (e.g., second device 106, and/or other devices) information of a failed transmission from a source device (e.g., first device 104, and/or other devices) via the communication interface 113 and while a wireless data connection (e.g., the second wireless data connection) is established. Additionally or alternatively, in some examples, the intelligent transmission platform 102 may intercept the information of the failed transmission via the one or more connections established at step 203. In some examples, the information of the failed transmission may be and/or comprise information of a file corresponding to the failed transmission. For example, the information of the failed transmission may be and/or comprise information of a file corresponding to the failed transmission (e.g., a file attached to and/or sent during the failed transmission) and comprising one or more of: a size of the file, a count corresponding to a number of additional files that correspond to the failed transmission (e.g., additional files included in the failed transmission from first device 104 to second device 106, or the like), a time corresponding to creation of the file corresponding to the failed transmission, a description (e.g., a file type, file name, and/or other description) of the file corresponding to the failed transmission, a speed corresponding to the failed transmission, and/or any other information of and/or related to a file corresponding to the failed transmission.

Referring to FIG. 2B, at step 205, the intelligent transmission platform 102 may identify a root cause of the failed transmission. For example, the intelligent transmission platform 102 may identify the root cause of the failed transmission based on inputting the information of the file corresponding to the failed transmission into the quantum analysis model. Inputting the information of the file corresponding to the failed transmission into the quantum analysis model may cause the quantum analysis model to identify the root cause based on correlations between the information of the file corresponding to the failed transmission and historical transmission information used to train the quantum analysis model. For example, based on inputting the information of the file into the quantum analysis model, the intelligent transmission platform 102 may cause the quantum analysis model to identify, based on one or more correlations stored in a the KEDB, a potential cause of the failed transmission that is the most likely root cause of the failed transmission. In these examples, the intelligent transmission platform 102 may cause the quantum analysis model to identify the root cause by comparing the information of the file to the one or more stored correlations. For example, based on information of the file indicating that the file size exceeds a threshold file size, the intelligent transmission platform 102 may cause the quantum analysis model to compare the file size to stored correlations for historical failed transmissions associated with files that also exceed the threshold file size and identify, based on the comparison, a most likely root cause of the failed transmissions. For instance, based on the comparison, the quantum analysis model may identify that a majority of the historical failed transmissions associated with files that also exceed the threshold file size correspond to a stored correlation between the historical failed transmissions and an indicator that a speed associated with the transmission was insufficient for file sizes exceeding the threshold file size. Accordingly, in these examples, the quantum analysis model may identify, based on the comparison, that the root cause of the failed transmission is that a speed (e.g., an upload/download speed, or the like) associated with the failed transmission was insufficient for the file size of the file corresponding to the failed transmission.

Additionally or alternatively, in some examples, the intelligent transmission platform 102 may cause the quantum analysis to perform one or more additional actions to identify the root cause of the failed transmission. For example, based on information of the file indicating that the file size of the file corresponding to the failed transmission is a particular size (e.g., 10 kb, and/or any other size) the intelligent transmission platform 102 may cause the quantum analysis model to access, at the first device 104, a resource database, a file server, and/or any other location, the actual file corresponding to the failed transmission. Based on accessing the actual file, the intelligent transmission platform 102 may cause the quantum analysis model to identify whether the actual file size matches the file size indicated by the information of the file received at step 204. Based on identifying that the actual file size matches the file size indicated by the information of the file, the intelligent transmission platform 102 may cause the quantum analysis model to continue identifying the root cause of the failed transmission. Based on identifying that the actual file size does not match the file size indicated by the information of the file, the intelligent transmission platform 102 may cause the quantum analysis model to identify the mismatched file size as the root cause of the failed transmission.

Additionally or alternatively, in some examples, the intelligent transmission platform 102 may cause the quantum analysis model to use one or more machine learning algorithms to identify the root cause of the failed transmission. For example, the intelligent transmission platform 102 may have previously trained the quantum analysis model to employ a similarity algorithm to identify the root cause based on a similarity score. The similarity algorithm may generate a similarity score indicating a similarity between the information of the file corresponding to the failed transmission and a historical failed transmission to identify the most likely root cause of the failed transmission. For example, quantum analysis model may implement a similarity algorithm using the following constraints/parameters:

$$If ( \frac{( n umber of stored correlations matching historical failed transmission )}{( total number of compared stored correlations )} ) \geq 0.5 , then : similarity score = ( 100 * \frac{( n umber of stored correlations matching historical failed transmission )}{( total number of compared stored correlations )} ) . If else , then : similarity score = 0.$$

In this example, the intelligent transmission platform 102 may cause the quantum analysis model to execute the similarity algorithm to identify whether, based on comparing the stored correlations matching the failed transmission to a particular historical failed transmission, the quotient of the number of stored correlations matching the failed transmission to the particular historical failed transmission divided by the total number of compared stored correlations meets or exceeds 50%. Based on identifying that the quotient meets or exceeds 50%, the quantum analysis model may generate a similarity score for the failed transmission and the historical failed transmission that is equal to 100 multiplied by the quotient. Else, the quantum analysis model may generate a similarity score of 0, indicating that the quantum analysis model will not identify the root cause based on stored correlations corresponding to the particular historical failed transmission.

In some examples, based on executing the algorithm, the quantum analysis model may compare the similarity score to a threshold to identify whether the most likely root cause of the failed transmission corresponds to a historical root cause of the historical failed transmission. For example, in the similarity algorithm example above, the quantum analysis model may compare the similarity score to a threshold score of 75%. If the quotient meets or exceeds 75%, the quantum analysis model may identify that the failed transmission corresponds to the historical failed transmission and, as a result, the root cause of the failed transmission corresponds to the root cause of the historical failed transmission. For example, if the quotient meets or exceeds 75%, the quantum analysis model may identify that the failed transmission from first device 104 to second device 106 corresponds to a historical failed transmission with a root cause of a mismatched file type and, as a result, the quantum analysis model may similarly identify that a mismatched file type was the root cause of the failed transmission from first device 104 to second device 106. If the quotient meets or exceeds 50% but does not meet or exceed 75%, the quantum analysis model might continue executing the similarity algorithm comparing the failed transmission to one or more additional historical failed transmissions. It should be understood that the above example is merely one algorithm the quantum analysis model may be trained to employ in order to generate the similarity score and/or identify the root cause of the failed transmission, and in one or more instances additional or alternative algorithms may be employed and/or may correspond to different parameters. Additionally, it should be understood that in some instances multiple issues may have caused the failed transmission and, in these instances, the intelligent transmission platform 102 may identify multiple root causes based on the methods of identifying root causes described above.

At step 206, based on identifying the root cause of the failed transmission, the intelligent transmission platform 102 may generate a reason log (e.g., a file, record, and/or other log of the failed transmission) for the failed transmission. For example, the intelligent transmission platform 102 may generate a reason log comprising an indication of the identified root cause of the failed transmission, time information related to the failed transmission (e.g., a time of transmission, a time of failure of the transmission, and/or other time information), metadata of one or more files associated with the failed transmission, a description of the one or more files associated with the failed transmission, and/or other information.

At step 207, the intelligent transmission platform 102 may store the reason log. For example, the intelligent transmission platform 102 may store the reason log in memory 112 and/or in external memory. In some examples, the intelligent transmission platform 102 may store the reason log as a training record which may, for example, be used in training one or more additional quantum analysis model and/or additional iterations of the quantum analysis model.

At step 208, based on identifying the root cause of the failed transmission, the intelligent transmission platform 102 may identify a predicted solution for the failed transmission. For example, the intelligent transmission platform 102 may cause the quantum analysis model to identify, based on the previously input information of the file corresponding to the failed transmission, the predicted solution for the failed transmission. In some examples, the intelligent transmission platform 102 may cause the quantum analysis model to identify the predicted solution based on one or more stored correlations used to train and/or configure the quantum analysis model. The intelligent transmission platform 102 may cause the quantum analysis model to identify a predicted solution corresponding to the identified root cause of the failed transmission. For example, if the identified root cause of the failed transmission is a mismatched speed of the transmission, the quantum analysis model may identify, based on a stored correlation between mismatched speeds of transmissions and the solution of compressing a file, compressing the file as the predicted solution for the failed transmission. In some examples, the intelligent transmission platform 102 may identify multiple predicted solutions based on identifying multiple root causes of the failed transmission.

Additionally or alternatively, in some examples, in identifying the predicted solution for the failed transmission the intelligent transmission platform 102 may identify whether the predicted solution is resolvable by the quantum analysis model. A predicted solution may be resolvable by the quantum analysis model if the quantum analysis model is capable of causing, based on implementing the predicted solution, the file corresponding to the failed transmission to be successfully transmitted to the destination device (e.g., second device 106, and/or other devices). Identifying whether the predicted solution is resolvable by the quantum analysis model may be and/or comprise the first step in initiating a response to the failed transmission. In identifying the predicted solution, the intelligent transmission platform 102 may cause the quantum analysis model to identify whether the predicted solution requires resources and/or actions corresponding to devices other than the intelligent transmission platform 102. For example, the intelligent transmission platform 102 may identify whether the predicted solution is a solution action (e.g., generating executable code configured to resolve one or more errors associated with the failed transmission, sending a recommendation of one or more actions configured to resolve one or more errors associated with the failed transmissions, and/or other solution actions) resolvable by the intelligent transmission platform 102 and/or the quantum analysis model or an action unresolvable by the intelligent transmission platform 102 and/or the quantum analysis model. For example, based on a predicted solution indicating that the file corresponding to the failed transmission is a corrupted file, the intelligent transmission platform 102 may cause the quantum analysis model to identify that the intelligent transmission platform 102 and/or the quantum analysis model lacks the resources, permissions, and/or other requirements to repair or replace the corrupted file. Additionally or alternatively, based on a predicted solution indicating that the failed transmission is resolvable by generating executable code to modify a file type of a file associated with the failed transmission, the intelligent transmission platform 102 may cause the quantum analysis model to identify that the intelligent transmission platform 102 and/or the quantum analysis model is capable of resolving the predicted solution.

In some examples, based on identifying a predicted solution that is not resolvable by the intelligent transmission platform 102 and/or the quantum analysis model, the intelligent transmission platform 102 may proceed to step 209. Based on identifying a prediction solution that is resolvable by the intelligent transmission platform 102 and/or the quantum analysis model, the intelligent transmission platform 102 may proceed to step 210 without performing the functions recited at step 209.

Referring to FIG. 2C, at step 209, based on identifying that the predicted solution is not resolvable by the intelligent transmission platform 102 and/or the quantum analysis model (e.g., based on identifying that implementing the predicted solution will not cause the file corresponding to the failed transmission to be successfully transmitted to the destination device), the intelligent transmission platform 102 may erase the file corresponding to the failed transmission. For example, the intelligent transmission platform 102 may send one or more instructions directing the device (e.g., first device 104, and/or other devices) storing the file corresponding to the failed transmission to erase the file corresponding to the failed transmission. In these examples, the file corresponding to the failed transmission may be a corrupted file and the predicted solution may be to erase the corrupted file and send a new transmission with an uncorrupted version of the file and/or a new file. Based on erasing the file corresponding to the failed transmission, the intelligent transmission platform 102 may proceed to step 211 without performing the functions recited at step 210.

At step 210, based on identifying a predicted solution that is resolvable by the intelligent transmission platform 102 and/or the quantum analysis model, the intelligent transmission platform 102 may generate and/or implement an actual solution action corresponding to the failed transmission. The intelligent transmission platform 102 may generate and/or implement the actual solution action based on the predicted solution. In some examples, the actual solution action may comprise generating, using the quantum analysis model, executable code configured to resolve one or more errors associated with the failed transmission. The quantum analysis model may generate the executable code based on one or more stored correlations associated with implemented solution actions corresponding to one or more failed historical transmissions. For example, based on a stored correlation indicating that a failed historical transmission caused implementation of executable code configured to resend a transmission, locate a file corresponding to the failed historical transmission, re-establish a connection to a destination device of the failed historical transmission, and/or perform other functions, the intelligent transmission platform 102 may cause the quantum analysis model to generate similar executable code configured to resolve one or more errors associated with the failed transmission from first device 104 to second device 106. Additionally or alternatively, in some instances, the actual solution action may comprise generating and/or sending, to the source device (e.g., first device 104, and/or other devices) a recommendation of one or more actions configured to resolve one or more errors associated with the failed transmission. For example, based on identifying that the root cause of the failed transmission was a mismatched file size, the intelligent transmission platform 102 may generate and/or send a recommendation to the first device 104 recommending and/or instructing the first device 104 to compress the file corresponding to the failed transmission, and/or otherwise address the mismatched file size.

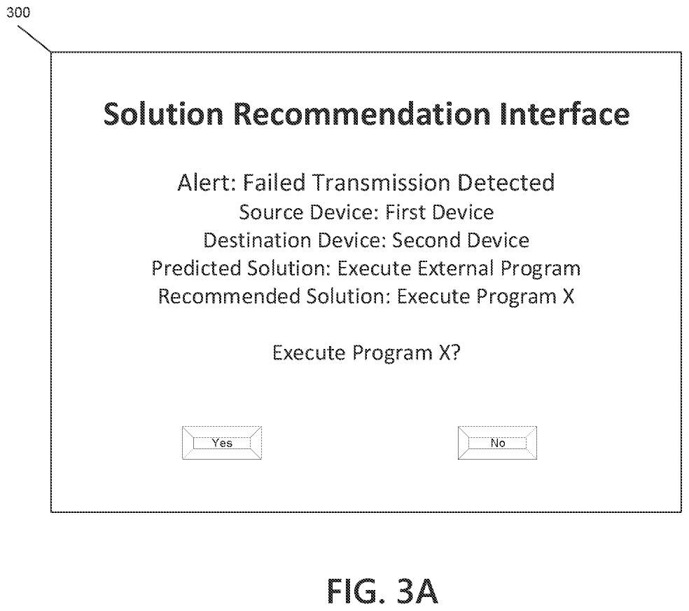

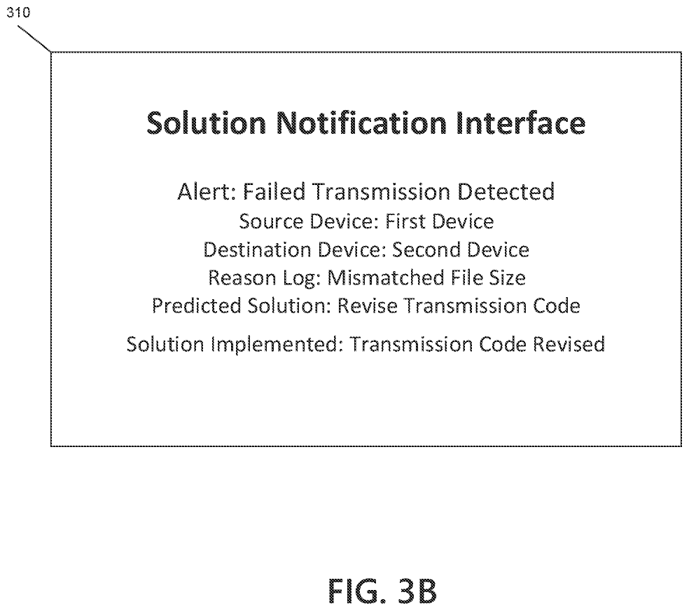

In some examples, sending the recommendation may additionally or alternatively comprise causing display of a user interface at one or more user devices. For example, the intelligent transmission platform 102 may cause display of a user interface (e.g., a solution recommendation interface, and/or other user interfaces) at the first device 104. For example, the intelligent transmission platform 102 may cause display of the user interface via the communication interface 113 and while the first wireless data connection is established. In causing display of the user interface, the intelligent transmission platform 102 may transmit and cause display of a solution recommendation interface for recommending an actual solution action and prompting the first device 104 to implement the actual solution action. In displaying the solution recommendation interface, the intelligent transmission platform 102 may cause display of a graphical user interface similar to solution recommendation interface 300, which is illustrated in FIG. 3A. For example, the intelligent transmission platform 102 may output one or more instructions (via the communication interface 113 and while the first wireless data connection is established) to the first device 104, causing the first device 104 to display the solution recommendation interface 300.

Referring to FIG. 3A, in some instances, the solution recommendation interface 300 may include information corresponding to the recommendation of one or more actions (i.e., actual solution actions) configured to resolve one or more errors associated with the failed transmission. For example, the solution recommendation interface 300 may include information such as a notification that a failed transmission was detected by the intelligent transmission platform 102, an indication of the source device associated with the failed transmission, an indication of the destination device associated with the failed transmission, a description, list, and/or other indication of the predicted solution, a description, summary, and/or other indication of the recommended actual solution action or actions, and/or other information. The solution recommendation interface 300 may also display interface elements or selectable options requesting user input. For example, the solution recommendation interface 300 may display one or more of: an information entry field, a button or buttons, toggle or toggles, check box or boxes, and/or other interface elements. For example, as illustrated in FIG. 3A, the interface elements may be one or more buttons the user might toggle or select to implement a recommended solution for the failed transmission. In some instances, based on user input/determinations of whether to initiate a recommended solution, one or more devices (e.g., the intelligent transmission platform 102, the first device 104, and/or other devices) may implement the recommended solution.

Referring back to FIG. 2C and step 210, it should be understood that the above examples are merely illustrative and that one or more additional or alternative actual solution actions may be generated and/or implemented by the intelligent transmission platform 102 without departing from the scope of this disclosure.

At step 211, based on erasing a file corresponding to the failed transmission or based on generating and/or implementing the actual solution action, the intelligent transmission platform 102 may cause the failed transmission to complete successfully as part of a response to the failed transmission. For example, in some instances, based on erasing the file corresponding to the failed transmission, the intelligent transmission platform 102 may cause the device that erased the file (e.g., first device 104, and/or other devices) to initiate a new transmission with a new and/or corrected file by sending one or more instructions to the device that erased the file to initiate the new transmission. In some examples, based on generating and/or implementing the actual solution action, the intelligent transmission platform 102 may cause the failed transmission to complete successfully by correcting the root cause of the failed transmission. For example, based on generating executable code configured to resolve the root cause of the failed transmission, the intelligent transmission platform 102 may execute the executable code and causing the failed transmission to complete successfully without requiring the first device 104 to re-send the transmission or send a new transmission.

At step 212, the intelligent transmission platform 102 may cause output of a notification. For example, based on initiating a response to the failed transmission (e.g., erasing the file corresponding to the failed transmission, generating and/or implementing the actual solution action, and/or otherwise initiating a response to the failed transmission), the intelligent transmission platform 102 may output, to the first device 104, a notification of the response to the failed transmission. In some examples, the intelligent transmission platform 102 may cause output of the notification by causing display of a user interface (e.g., a solution notification interface, and/or other user interfaces) at the first device 104. For example, the intelligent transmission platform 102 may cause display of the user interface via the communication interface 113 and while the first wireless data connection is established. In causing display of the user interface, the intelligent transmission platform 102 may transmit and cause display of a solution notification interface alerting the first device 104 of the failed transmission and summarizing the predicted solution. In displaying the solution notification interface, the intelligent transmission platform 102 may cause display of a graphical user interface similar to solution notification interface 310, which is illustrated in FIG. 3B. For example, the intelligent transmission platform 102 may output one or more instructions (via the communication interface 113 and while the first wireless data connection is established) to the first device 104, causing the first device 104 to display the solution notification interface 310.

Referring to FIG. 3B, in some instances, the solution notification interface 310 may include information corresponding to the failed transmission and/or the implemented actual solution action. For example, the solution notification interface 310 may include information such as the output notification of the failed transmission, an indication of the source device associated with the failed transmission, an indication of the destination device associated with the failed transmission, a description, list, and/or other indication of the predicted solution, a description, summary, and/or other indication of the actual solution action or actions implemented (e.g., as described at step 210), and/or other information.

Referring to FIG. 2D, at step 213, the intelligent transmission platform 102 may update the quantum analysis model. In updating the quantum analysis model, the intelligent transmission platform 102 may refine, validate, and/or otherwise update the quantum analysis model. For example, the intelligent transmission platform 102 may update the quantum analysis model based on the predicted solution generated by the intelligent transmission platform 102. In some instances, updating the quantum analysis model may comprise inputting the predicted solution into the quantum analysis model. By inputting the predicted solution into the quantum analysis model, the intelligent transmission platform 102 may create an iterative feedback loop that may continuously and dynamically refine the quantum analysis model to improve its accuracy in identifying predicted solutions. For example, based on inputting the predicted solution into the quantum analysis model, the intelligent transmission platform 102 may cause the quantum analysis model to store and/or update one or more stored correlations for future iterations of the feedback loop. For example, based on the predicted solution, the intelligent transmission platform 102 may cause the quantum analysis model to store a correlation between the root cause of the failed transmission and the predicted solution which may, for example, be used by the quantum analysis model as part of an algorithm, as part of a comparison, and/or otherwise used to identify predicted solutions to root causes of failed transmissions in future iterations of the feedback loop.

Additionally or alternatively, in some instances, the intelligent transmission platform 102 may update the quantum analysis model based on the stored reason log corresponding to the failed transmission. For example, the intelligent transmission platform 102 may input the stored reason log into the quantum analysis model as a new training record configured to refine, validate, and/or otherwise update the quantum analysis model to improve its accuracy. For example, inputting the stored reason log may cause the intelligent transmission platform 102 to repeat some or all of the functions of step 201 to train the quantum analysis model to identify root causes of failed transmissions and to identify predicted solutions to the root causes based, in part, on the information of the stored reason log. In updating the quantum analysis model, the intelligent transmission platform 102 may remove redundant correlations and/or maintain a set of relevant correlations based on the stored reason log and/or the predicted solution to the failed transmission, which may, e.g., result in more efficient training of machine learning models (and may in some instances, conserve computing and/or processing power/resources in doing so).

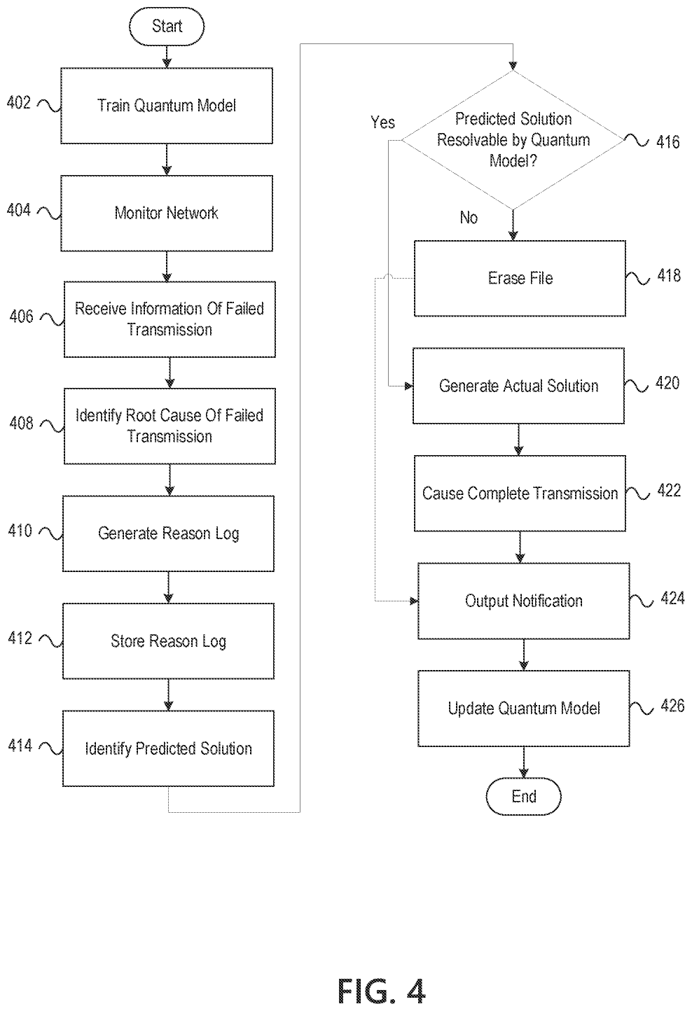

FIG. 4 depicts an illustrative method for a quantum-enabled intelligent transmission system in accordance with one or more example arrangements. Referring to FIG. 4, at step 402, a computing platform having at least one processor, a communication interface, and memory may train a quantum model. For example, the computing platform may train a quantum analysis machine learning model to identify predicted solutions and output actual solution actions based on input of information of failed transmissions. At step 404, the computing platform may monitor a network for failed transmissions. At step 406, the computing platform may receive information of a failed transmission. At step 408, the computing platform may identify a root cause of the failed transmission. For example, the computing platform may identify the root cause of the failed transmission based on inputting the information of the failed transmission into the quantum analysis model. At step 410, the computing platform may generate a reason log comprising information of the failed transmission. At step 412, the computing platform may store the reason log. At step 414, the computing platform may identify a predicted solution for the failed transmission. For example, the computing platform may identify the predicted solution using the quantum analysis model.

At step 416, the computing platform may identify whether the predicted solution is resolvable by the quantum analysis model. Based on identifying that the predicted solution is resolvable by the quantum analysis model, the computing platform may proceed to step 420. Based on identifying that the predicted solution is not resolvable by the quantum analysis model, the computing platform may proceed to step 418. At step 418, based on identifying that the predicted solution is not resolvable by the quantum analysis model, the computing platform may erase a file corresponding to the failed transmission. Based on erasing the file, the computing platform may proceed to step 424. At step 420, based on identifying that the predicted solution is resolvable by the quantum analysis model, the computing platform may generate an actual solution action. For example, the computing platform may generate an actual solution action corresponding to the predicted solution and configured to resolve the root cause of the failed transmission. At step 422, the computing platform may cause successful completion of the failed transmission. At step 424, the computing platform may cause output of a notification. For example, the computing platform may cause output of a notification to the source device of the failed transmission indicating that the transmission failed and a solution has been implemented. At step 426, the computing platform may update the quantum analysis model. For example, the computing platform may update the quantum analysis model based on the predicted solution and/or based on the stored reason log.

One or more aspects of the disclosure may be embodied in computer-usable data or computer-executable instructions, such as in one or more program modules, executed by one or more computers or other platforms to perform the operations described herein. Generally, program modules include routines, programs, objects, components, data structures, and the like that perform particular operations or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various arrangements. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative arrangements, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative arrangements thereof. Numerous other arrangements, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform comprising:
at least one processor;
a communication interface communicatively coupled to the at least one processor; and
memory storing computer-readable instructions that, when executed by the at least one processor, configure the computing platform to:
train, based on historical transmission information, a quantum analysis model, wherein training the quantum analysis model configures the quantum analysis model to identify predicted solutions and output actual solution actions based on input of information of failed transmissions;
receive, based on a failed transmission from a first device to a second device, information of a file corresponding to the failed transmission;
identify, based on inputting the information of the file into the quantum analysis model, a root cause of the failed transmission;
identify, based on identifying the root cause of the failed transmission and using the quantum analysis model, a predicted solution for the failed transmission;
cause, based on identifying the predicted solution for the failed transmission, initiation of a response to the failed transmission, wherein the response to the failed transmission comprises:
identifying, using the quantum analysis model, whether the predicted solution is resolvable by the quantum analysis model;
based on identifying that the predicted solution is resolvable by the quantum analysis model, implementing an actual solution action corresponding to the failed transmission; and
based on identifying that the predicted solution is not resolvable by the quantum analysis model, erasing the file corresponding to the failed transmission;
cause, based on the initiation of the response to the failed transmission and to the first device, output of a notification of the response to the failed transmission; and
update, based on the predicted solution, the quantum analysis model.

2. The computing platform of claim 1, wherein implementing the actual solution action comprises one or more of:
generating, using the quantum analysis model, executable code configured to resolve one or more errors associated with the failed transmission, or
sending, to the first device, a recommendation of one or more actions configured to resolve one or more errors associated with the failed transmission.

3. The computing platform of claim 1, wherein identifying the root cause of the failed transmission comprises:
comparing, using the quantum analysis model, the information of the file corresponding to the failed transmission to one or more stored correlations corresponding to the historical transmission information; and
identifying, based on the comparison, whether the root cause corresponds to a historical root cause of a historical failed transmission.

4. The computing platform of claim 1, wherein the memory stores additional instructions that, when executed by the at least one processor, further configure the computing platform to:
generate, based on identifying the root cause of the failed transmission, a reason log corresponding to the failed transmission; and
store the reason log as a training record,
wherein the updating the quantum analysis model is further based on the stored reason log.

5. The computing platform of claim 1, wherein the historical transmission information comprises one or more reason logs, wherein a given reason log of the one or more reason logs comprises one or more of:
an indication of a reason for a failed transmission,
an indication of information sent during a failed transmission,
timing information related to a failed transmission, or
a speed associated with a failed transmission.

6. The computing platform of claim 1, wherein the memory stores additional instructions that, when executed by the at least one processor, further configure the computing platform to:
monitor, via a shared connection over a network, communications between the first device and the second device for failed transmissions.

7. The computing platform of claim 1, wherein the information of the file corresponding to the failed transmission comprises one or more of:
a size of the file corresponding to the failed transmission,
a count corresponding to a number of additional files corresponding to the failed transmission,
a time corresponding to creation of the file corresponding to the failed transmission,
a description of the file corresponding to the failed transmission, or
a speed corresponding to the failed transmission.

8. The computing platform of claim 1, wherein the memory stores additional instructions that, when executed by the at least one processor, further configure the computing platform to:
cause, based on initiation of the response to the failed transmission, completion of the failed transmission.

9. A method comprising:
at a computing device comprising least one processor, a communication interface, and memory:
training, based on historical transmission information, a quantum analysis model, wherein training the quantum analysis model configures the quantum analysis model to identify predicted solutions and output actual solution actions based on input of information of failed transmissions;
receiving, based on a failed transmission from a first device to a second device, information of a file corresponding to the failed transmission;
identifying, based on inputting the information of the file into the quantum analysis model, a root cause of the failed transmission;
identifying, based on identifying the root cause of the failed transmission and using the quantum analysis model, a predicted solution for the failed transmission;
causing, based on identifying the predicted solution for the failed transmission, initiation of a response to the failed transmission, wherein the response to the failed transmission comprises:
identifying, using the quantum analysis model, whether the predicted solution is resolvable by the quantum analysis model;
when the predicted solution is resolvable by the quantum analysis model, implementing an actual solution action corresponding to the failed transmission;
and
when the predicted solution is not resolvable by the quantum analysis model, erasing the file corresponding to the failed transmission;
causing, based on the initiation of the response to the failed transmission and to the first device, output of a notification of the response to the failed transmission; and
updating, based on the predicted solution, the quantum analysis model.

10. The method of claim 9, wherein implementing the actual solution action comprises one or more of:
generating, using the quantum analysis model, executable code configured to resolve one or more errors associated with the failed transmission, or
sending, to the first device, a recommendation of one or more actions configured to resolve one or more errors associated with the failed transmission.

11. The method of claim 9, wherein identifying the root cause of the failed transmission comprises:
comparing, using the quantum analysis model, the information of the file corresponding to the failed transmission to one or more stored correlations corresponding to the historical transmission information; and
identifying, based on the comparison, whether the root cause corresponds to a historical root cause of a historical failed transmission.

12. The method of claim 9, further comprising:
generating, based on identifying the root cause of the failed transmission, a reason log corresponding to the failed transmission; and
storing the reason log as a training record,
wherein the updating the quantum analysis model is further based on the stored reason log.

13. The method of claim 9, further comprising:
monitoring, via a shared connection over a network, communications between the first device and the second device for failed transmissions.

14. The method of claim 9, further comprising:
causing, based on initiation of the response to the failed transmission, completion of the failed transmission.

15. One or more non-transitory computer-readable media storing instructions that, when executed by a computing platform comprising at least one processor, a communication interface, and memory, cause the computing platform to:
train, based on historical transmission information, a quantum analysis model, wherein training the quantum analysis model configures the quantum analysis model to identify predicted solutions and output actual solution actions based on input of information of failed transmissions;
receive, based on a failed transmission from a first device to a second device, information of a file corresponding to the failed transmission;
identify, based on inputting the information of the file into the quantum analysis model, a root cause of the failed transmission;
identify, based on identifying the root cause of the failed transmission and using the quantum analysis model, a predicted solution for the failed transmission;
cause, based on identifying the predicted solution for the failed transmission, initiation of a response to the failed transmission, wherein the response to the failed transmission comprises:
identifying, using the quantum analysis model, whether the predicted solution is resolvable by the quantum analysis model;
based on identifying that the predicted solution is resolvable by the quantum analysis model, implementing an actual solution action corresponding to the failed transmission; and
based on identifying that the predicted solution is not resolvable by the quantum analysis model, erasing the file corresponding to the failed transmission;
cause, based on the initiation of the response to the failed transmission and to the first device, output of a notification of the response to the failed transmission; and
update, based on the predicted solution, the quantum analysis model.

16. The one or more non-transitory computer-readable media of claim 15, wherein implementing the actual solution action comprises one or more of:
generating, using the quantum analysis model, executable code configured to resolve one or more errors associated with the failed transmission, or
sending, to the first device, a recommendation of one or more actions configured to resolve one or more errors associated with the failed transmission.

17. The one or more non-transitory computer-readable media of claim 15, wherein identifying the root cause of the failed transmission comprises:
comparing, using the quantum analysis model, the information of the file corresponding to the failed transmission to one or more stored correlations corresponding to the historical transmission information; and
identifying, based on the comparison, whether the root cause corresponds to a historical root cause of a historical failed transmission.

18. The one or more non-transitory computer-readable media of claim 15, storing instructions that, when executed, further cause the computing platform to:
generate, based on identifying the root cause of the failed transmission, a reason log corresponding to the failed transmission; and
store the reason log as a training record,
wherein the updating the quantum analysis model is further based on the stored reason log.

19. The one or more non-transitory computer-readable media of claim 15, storing instructions that, when executed, further cause the computing platform to:
monitor, via a shared connection over a network, communications between the first device and the second device for failed transmissions.

20. The one or more non-transitory computer-readable media of claim 15, storing instructions that, when executed, further cause the computing platform to:
cause, based on initiation of the response to the failed transmission, completion of the failed transmission.
